(19) United States
(12) Patent Application Publication
(10) Pub. No.: US 2014/0259080 A1
(43) Pub. Date: Sep. 11, 2014

(54) PORTABLE SATELLITE TELEVISION SYSTEM SWITCHABLE BETWEEN Ka AND Ku FREQUENCY BANDS

(71) Applicant: Electronic Controlled Systems, Inc., Bloomington, MN (US)

(72) Inventor: Lael King, New Prague, MN (US)

(73) Assignee: Electronic Controlled Systems, Inc., Bloomington, MN (US)

(21) Appl. No.: 14/205,282

(22) Filed: Mar. 11, 2014

Related U.S. Application Data
(60) Provisional application No. 61/776,426, filed on Mar. 11, 2013.

(51) Int. Cl. H01Q 3/04; H04H 40/90; H04N 7/20; H01Q 1/12

(52) U.S. Cl. CPC H01Q 3/04; H01Q 1/1264; H04H 40/90; H04N 7/20
USPC 725/72; 343/762

(57) ABSTRACT

The satellite antenna device, system and methods according to certain embodiments of the present invention can receive broadcast information on both of two different frequency bands by selectively switching an alignment position of the low noise block converter (LNB) with respect to a fixed wave guide assembly so that the inlets to the respective frequency band inlets to the LNB align with the wave guide according to the selected target satellite broadcast signal.

### PRIORITY

This application claims the priority benefit of U.S. Provisional Application No. 61/776,426, filed on Mar. 11, 2013, which is hereby incorporated herein by reference in its entirety.

### FIELD

The present invention relates generally to satellite television antenna systems and, more particularly, to a portable satellite television antenna system that can receive broadcast information on both of two different frequency bands by switching a position of the low noise block (LNB) converter between each of the reception positions of the LNB relative to a reflector dish.

### BACKGROUND

The growth in the number of available media channels and improved reception due to digital broadcasts has driven consumers to look beyond normal television antennas and cable systems. Digital signals broadcast from satellites are capable of providing hundreds of video, audio and data channels to users without the constraint of land line connections. The programming is distributed by a constellation of satellites parked in geostationary orbits at 22,300 miles above the earth. These broadcasts from orbit allow users to receive the broadcasts in many areas; such as mountainous regions or desolate areas, where earth-based transmitters or cable infrastructure traditionally are unable to reach.

A satellite has a finite broadcast bandwidth. Therefore, it is sometimes or often necessary for satellite programming providers, for example DISH Network and DirecTV, to spread their programming across more than one satellite located at different positions or slots in Earth's orbit. Thus, for a customer to receive their full compliment of programming, their satellite antenna equipment may need to aim and lock on to the two or more satellite positions (e.g. 110 degrees, 119 degrees, etc.) depending on what channel the user has chosen via their set top box. With the adoption of high definition (HD) programming, the proliferation of satellite positions or slots has become commonplace.

The Ku frequency band has been the bandwidth of choice for satellite television transmissions for more than a decade. However, some programming providers, such as DirecTV, have begun to utilize the Ka frequency bandwidth to broadcast some or all of the portions of the full compliment of programming that a user may wish to access. Thus, a satellite TV antenna may need to be able to receive broadcast signals in both of the Ku and Ka frequency bands depending on the channel that the user has selected (e.g., the so-called 99°, 101° and 103° satellite positions or slots).

With house-mounted antenna systems, a single relatively large dish with multiple feed horns and a corresponding multi-inlet low noise block signal converter (LNB) rigidly fixed to a reflector dish can be one-time adjusted as a unit in elevation, azimuth and skew degrees of freedom so that the data being broadcast from multiple different satellites and on multiple frequency bands (and even different frequencies on those bands) can all be received simultaneously by the respective LNB inlets without the need to move the various components again. Alternatively, multiple separate dishes may be used, wherein each is configured and aimed corresponding to a specific satellite slot. In either case, once the dish is properly aimed and secured, it is not necessary to re-adjust because the house does not move. Often a trained technician is hired to perform the setup and aiming tasks because it must be ensured that the antenna(s) are accurately aimed at the correct satellite or satellites corresponding to the programming package to which the user has subscribed.

Providing a solution for mobile environments (such as recreational vehicles (RVs) and for persons tailgating/camping) is a far more complex endeavor due to the small desired size of the antenna device and device complexity issues. Placing a “home” antenna on the roof of an RV is less than ideal. The large size prevents the antenna from being enclosed and the antenna would have to be deployed and retracted with each use. In-motion use also would not be possible because of the height and wind resistance of the required dish. Moreover, the antenna would also have to be quite complex because it would be necessary to adjust for skew in addition to elevation and azimuth.

With conventional portable and enclosed satellite television antennas, only one satellite position can be seen at a time. This allows the systems to be made less expensive and smaller than they otherwise would because only elevation and azimuth aiming positions need to be motorized. A single dish with multiple signal converters necessitates a much larger antenna and also the need to motorize the skew of the antenna. Thus, conventional multi-signal converter systems for mobile applications are large and expensive. Further, placing such a system in an enclosure, which is typical, is undesirable due to the unwieldy and impractical large size and shape of the enclosure that would be required. Thus, portable applications requiring size restrictions such as mounting on the roof of an RV or carrying by hand are not possible. Therefore there remains a need to provide an improved satellite television antenna that can receive broadcast television signals on both Ku and Ka frequency bands, while addressing some or all of the above-noted drawbacks.

### SUMMARY

The present invention addresses certain deficiencies discussed above by providing for a device, method and system of a portable satellite television antenna that can receive broadcast information on both Ku and Ka frequency bands by switching a position of the low noise block converter between Ku and Ka reception positions.

In one example embodiment, a method of receiving satellite TV broadcasts from a first broadcast satellite broadcasting in a first frequency band and from a second broadcast satellite broadcasting in a second frequency band is provided. The method includes moving a low noise block converter (LNB) horizontally (or vertically, diagonal, etc.) with respect to a reflector dish from a first alignment position corresponding to the first broadcast satellite to a second alignment position corresponding to the second broadcast satellite. In the first alignment position, a first inlet to the LNB corresponding to the first broadcast satellite is aligned with a wave guide extending forwardly from the reflector dish. In the second alignment position, a second inlet to the LNB corresponding to the second broadcast satellite is aligned with the wave guide.

In another example embodiment, a portable satellite television antenna system configured to receive satellite television broadcasts from a first broadcast satellite broadcasting in a first frequency band and from a second broadcast satellite broadcasting in a second frequency band, the antenna further configured to utilize a LNB including a first inlet corresponding to the first frequency band and a second inlet corresponding to the second frequency band, is disclosed. The system includes a reflector dish having a front reflector side and a back side. A wave guide extends forward of the front side of the reflector dish. A slider mechanism is disposed behind the back side of the reflector dish and includes the LNB coupled thereto. The slider mechanism defines a first position wherein the first inlet of the LNB is with the wave guide and a second position wherein the second inlet of the LNB is aligned with the wave guide. The slider mechanism is configured to slide linearly from the first position to the second position. A slide motor is coupled to the slider mechanism to slide the slider between the first position and the second position.

In a further example embodiment, a LNB adjustment system for adjusting the alignment of the LNB of a portable satellite television antenna with respect to a wave guide fixedly disposed on a front side of a reflector dish is disclosed. The system includes a base plate fixedly coupled to a rear side of the reflector dish and a sliding plate slidingly coupled to the base plate. A slide motor is fixedly coupled to the sliding plate and includes a drive shaft operably coupled to the base plate. The LNB is secured to the sliding plate.

The satellite antenna device according to certain embodiments may provide easy satellite television reception on both Ku and Ka frequency bands while camping, tailgating, ice fishing, visiting summer cabin, etc. The system requires no deployment and is enclosed in a light weight, small enclosure with, or without a carrying handle. The antenna can be set up anywhere with a clear view of the southern sky. The system according to certain embodiments can also be configured for permanent or removable mounting to a vehicle such as RV.

In certain embodiments the system is microprocessor controlled. Such system looks for satellite locations, aims at a particular satellite of interest and acquires satellite identification information from a set top box, an internal tuner demodulator or other means for each of the satellites or satellite combinations of interest. The system may include a motor driven satellite antenna with two degrees of freedom and a LNB switching mechanism. Other embodiments, features and functions will be apparent from the detailed description below, and from the appended figures.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a perspective view of a wave guide assembly according to certain example embodiments.

FIG. 2 is a longitudinal cross-sectional side view a wave guide assembly according to certain example embodiments.

FIG. 3 is a perspective exploded component view of a wave guide assembly according to certain example embodiments.

FIG. 4 is a perspective view of a wave guide according to certain example embodiments.

FIG. 5 is a top view of a wave guide according to certain example embodiments.

FIG. 6 is a side view of a wave guide according to certain example embodiments.

FIG. 7 is a bottom view of a wave guide according to certain example embodiments.

FIG. 8 is a cross-sectional side view of the wave guide of FIG. 7 taken along line A-A, according to certain example embodiments.

FIG. 9 is a perspective view of a phase shifter according to certain example embodiments.

FIG. 10 is a side view of a phase shifter according to certain example embodiments.

FIG. 11 is a front view of a phase shifter according to certain example embodiments.

FIG. 12 is a perspective view of a spacer according to certain example embodiments.

FIG. 13 is a bottom view of a spacer according to certain example embodiments.

FIG. 14 is a side view of a spacer according to certain example embodiments.

FIG. 15 is a cross sectional side view of the spacer of FIG. 12 according to certain example embodiments.

FIG. 16 is a top view of a spacer according to certain example embodiments.

FIG. 17 is a perspective view of a sub-reflector according to certain example embodiments.

FIG. 18 is a top view of a sub-reflector according to certain example embodiments.

FIG. 19 is a side-cross-sectional view of a sub-reflector according to certain example embodiments.

FIG. 20 is a side view of a sub-reflector according to certain example embodiments.

FIG. 21 is a bottom view of a sub-reflector according to certain example embodiments.

FIG. 22 is a perspective view of a wave guide spacer according to certain example embodiments.

FIG. 23 is a front side view of a wave guide spacer according to certain example embodiments.

FIG. 24 is a top view of a wave guide spacer according to certain example embodiments.

FIG. 25 is a rear side view of a wave guide spacer according to certain example embodiments.

FIG. 26 is an end view of a wave guide spacer according to certain example embodiments.

FIG. 27 is a bottom view of a wave guide spacer according to certain example embodiments.

FIG. 28 is a perspective exploded component view of a portable satellite television antenna apparatus according to certain example embodiments.

FIG. 29 is another perspective exploded component view of a portable satellite television antenna apparatus according to certain example embodiments.

FIG. 30 is a top view of a portable satellite television antenna apparatus in a first receiving configuration according to certain example embodiments.

FIG. 31 is a top view of a portable satellite television antenna apparatus in a second receiving configuration according to certain example embodiments.

FIG. 32 is a top view of a portable satellite television antenna apparatus in a third receiving configuration according to certain example embodiments.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purpose of illustration rather than to limit the present invention. The various features or aspects discussed herein can also be combined in additional combinations and embodiments, whether or not explicitly discussed herein, without departing from the scope of the invention,

The portable satellite antenna system described herein can take many forms, both enclosed and non-enclosed. Suitable satellite antenna devices that can be adapted according to the various aspects of the present invention include those disclosed in U.S. Pat. No. 7,595,764 and U.S. Published Pat. App. No. 2011/0030015 A1, both of which are hereby incorporated by reference herein in their entirety. The portable satellite antenna system can be configured for standing on the ground or a surface, for mounting on the roof of a vehicle (e.g. a recreational vehicle), on a stand, or attaching to a mounting bracket.

Various Figures indicate certain dimensional information for one preferred embodiment of the wave guide. These dimensions correspond with the example use of a 15-inch diameter circular parabolic reflector dish and the dimensions of the other components as indicated in this specification. The indicated dimensions are optimized for a balanced tradeoff of signal strength between Ka and Ku bands so that television can be successfully watched on both bands with the same antenna using a single wave guide. In contrast, a waveguide and associated components optimized for maximum signal strength on only one of the Ka or Ku bands may not provide acceptable reception of the other non-optimized frequency band. It should be recognized, however, that the dimensions and configurations of components depicted in the figures are merely one example embodiment. Certain dimensions can be scaled for larger and smaller dish diameters. The dimensions and shaping can also be altered to be optimized according to the invention to be suitable for other dish shapes and sizes (e.g. in the range of 12-18 inches diameter) unless specific dimensions and/or shapes are specified in a given claim. Thus, the dimensions can be varied without departing from the scope of the invention. The dimensions of the components can be varied for many reasons, including for example, to account for optimization of specific Ku and Ka frequency ranges, for changes in dish size and for changes in various dimensions of other components in the antenna system.

Additionally, the system, devices and method herein are not limited to use with only the Ka and Ku bands. The system can be configured to be used with other bands without departing from the scope of the invention unless explicitly limited in a given claim.

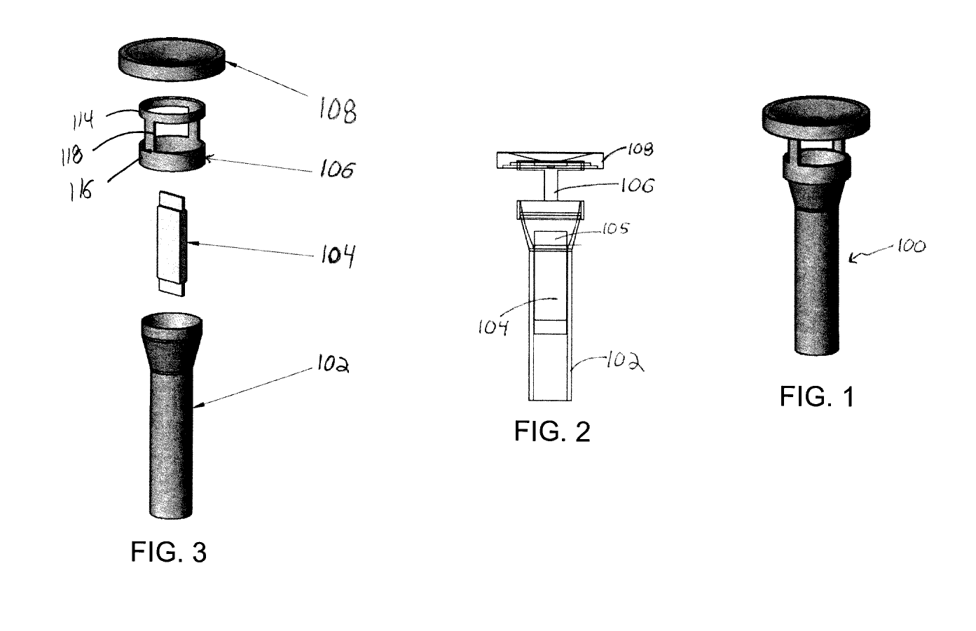

Referring first to FIGS. 1-3, a waveguide assembly 100 for one example embodiment of the antenna device is shown. The assembly comprises a wave guide 102, a phase shifter 104, a spacer 106 and a sub reflector 108. The phase shifter 104 is disposed inside of the hollow inner diameter of the wave guide 102 such that the tongue 105 of the phase shifter 104 is positioned at the beginning of the cone transition of the wave guide. The phase shifter 104 is also aligned axially within the wave guide to be parallel with a plane through the center points of the inlets to the LNB. The window spacer 106 is disposed on the outer end of the wave guide 102 that is most remote from the reflector dish. The sub reflector 108 is coupled with the top portion of the spacer 106 opposite the end of the wave guide 102 on which the spacer is disposed.

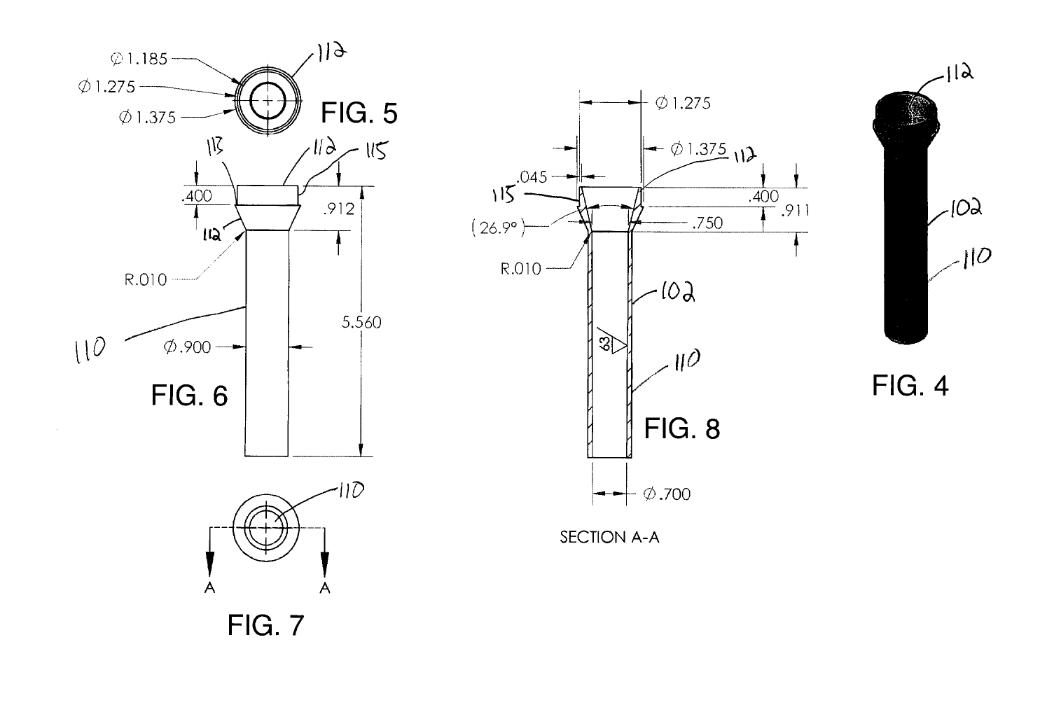

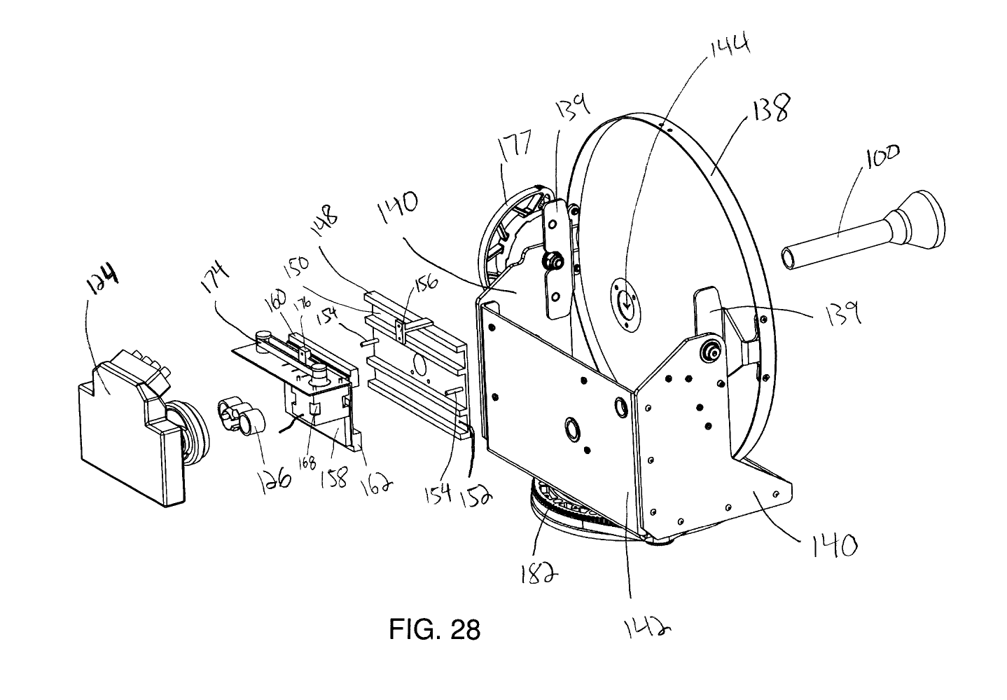

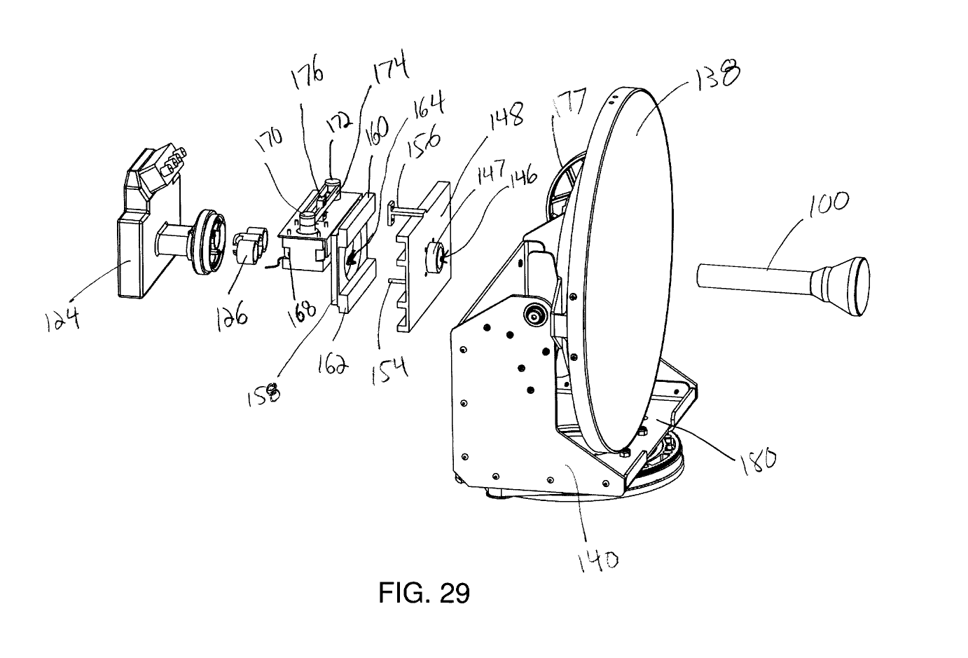

Referring to FIGS. 4-8, additional details of the wave guide 102 can be seen. The wave guide comprises a hollow cylindrical portion 110 and a hollow conical portion 112. The conical portion 112 is positioned opposite the reflector dish as can be seen in FIGS. 28-29. The inside shape of the conical portion is also conical as shown in FIG. 8, with the radius diverging from the interface of the cylindrical portion outwards toward the outer end.

An outer ledge 113 is defined in a distal portion of the conical portion 112, at which point the outer surface defines parallel sides 115 in a side view. This shape defines a receiving portion for the spacer 106 as will be discussed herein below.

The wave guide 102 can be formed from various suitable materials such as plastics, metals (e.g. aluminum) and composites, or a combination thereof, that have electromagnetic wave reflecting properties or electromagnetic wave reflecting coating.

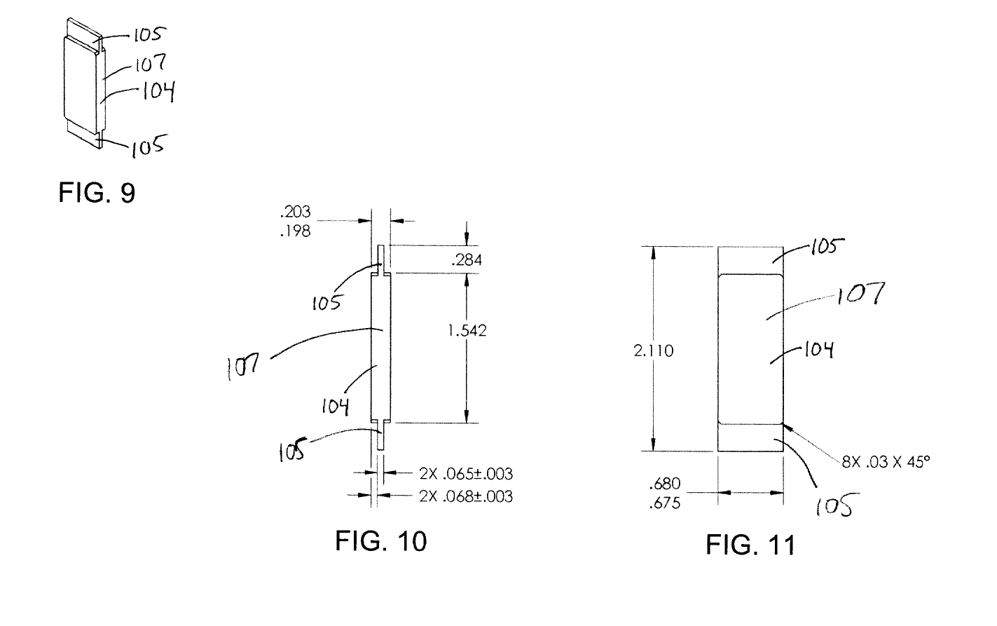

The phase shifter 104 is shown in greater detail in FIGS. 9-11. The phase shifter comprises a generally rectangular body 107 with a central narrow tongue or flange 105 extending outwardly away from each end. The phase shifter is disposed inside of the wave guide 102 as shown in FIGS. 2-3. The phase shifter may comprise REXOLITE® or other tuned dielectric material. One or both of the tongues 105 can be eliminated in certain embodiments. For example, the boom tongue closest to the reflector dish can be eliminated to optimize Ka band reception.

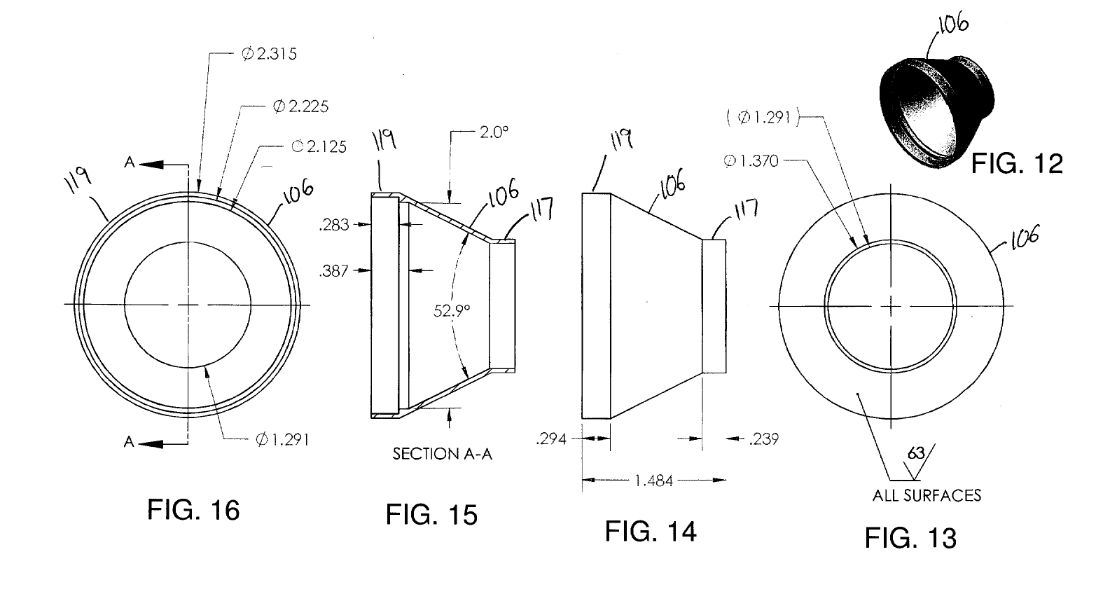

Referring to FIGS. 1-33 and 12-16, additional details of the spacer 106 can be seen. The spacer 106 shown in FIG. 3 differs in shape from that shown in FIGS. 12-16, but performs a similar function, to space the sub reflector 108 away from the distal end of the wave guide 102. The spacer 106 in FIG. 3 generally comprises first and second ring portions 114 and 116 with a plurality of support legs 118 disposed there between. The sub reflector 108 can be disposed on the upper cylindrical end 114 and the second cylindrical end 116 can be disposed on the outer flattened portion of the distal conical end 115 of the wave guide. Two support legs 118 are shown. However, more or fewer legs (and thinner legs) can be used without departing from the scope of the invention.

The spacer in FIGS. 12-16 generally comprises a hollow cone. A bottom end defines a cylindrical projection 117 for mating with the distal end 115 of the wave guide. The ledge 113 of the wave guide defines a stop point for the mating depth. The top end of the spacer 106 defines a cylindrical recess for receiving the sub reflector 108 therein.

The spacer 106 can comprise a variety of suitable materials, including metals, plastic and composites, or a combination thereof. In one such example, the spacer can comprise an electromagnetic wave permeable plastic.

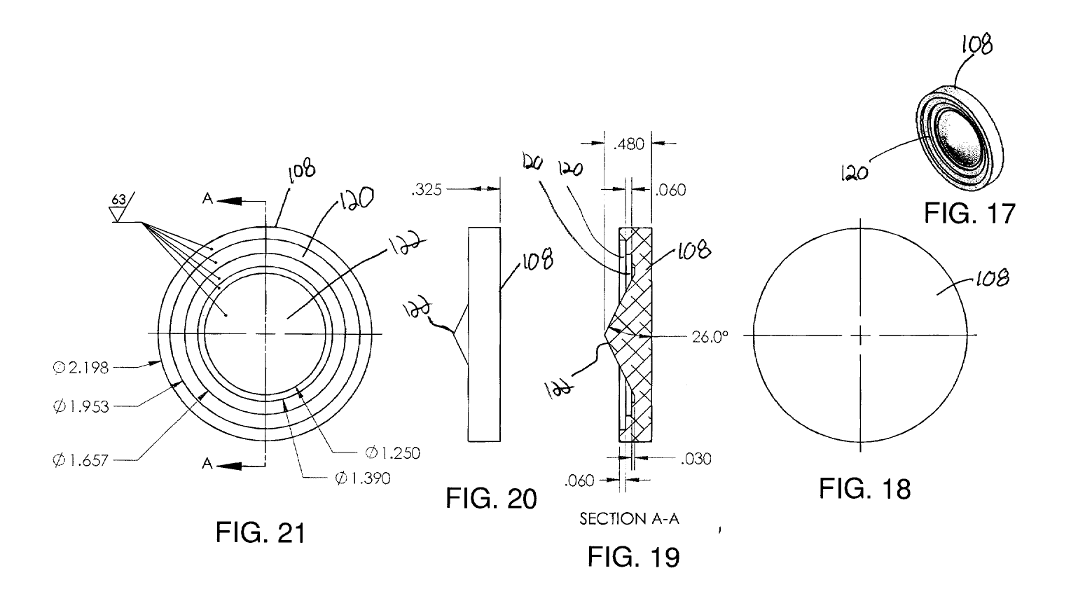

Referring to FIGS. 17-21, the sub reflector 108 is shown. The sub reflector 108 is generally disk-shaped and includes a plurality of concentric grooves or channels 120 defined into the disk body from an inward-facing (proximal or bottom) surface. The opposing surface faces away from the dish and is generally flat. A central conical protrusion 122 extends outward from the lower-most groove 120 defined inwards from the bottom surface. The surface having the grooves 120 is placed into the outer cylindrical end 119 of the spacer 106 and faces towards the spacer 106 and dish.

The sub reflector 108 can comprise a variety of suitable reflecting materials, including metals, plastic and composites, or a combination thereof. In one such example, the spacer can comprise aluminum. Plastics can be coated with a metal or other electromagnetic wave reflecting coating.

One suitable low-noise block converter (LNB) 124 that can be used with the present invention is a standard DirecTV Ka/Ku/Ka LNB with a portion of the inlet end machined down to accommodate the LNB spacer 126 (discussed below). The LNB 124 includes three adjacent, but separate, inlets corresponding to the first Ka satellite slot (e.g. 99°), the Ku satellite slot (e.g. 101°) and the second Ka satellite slot (e.g. 103°). Use of the standard DirecTV triple-LNB with only slight physical modification ensures that the satellite broadcast signals are fully compatible with the overall system. Of course, other LNBs may be used (including dual inlet or other multi-inlet) without departing from the scope of the invention.

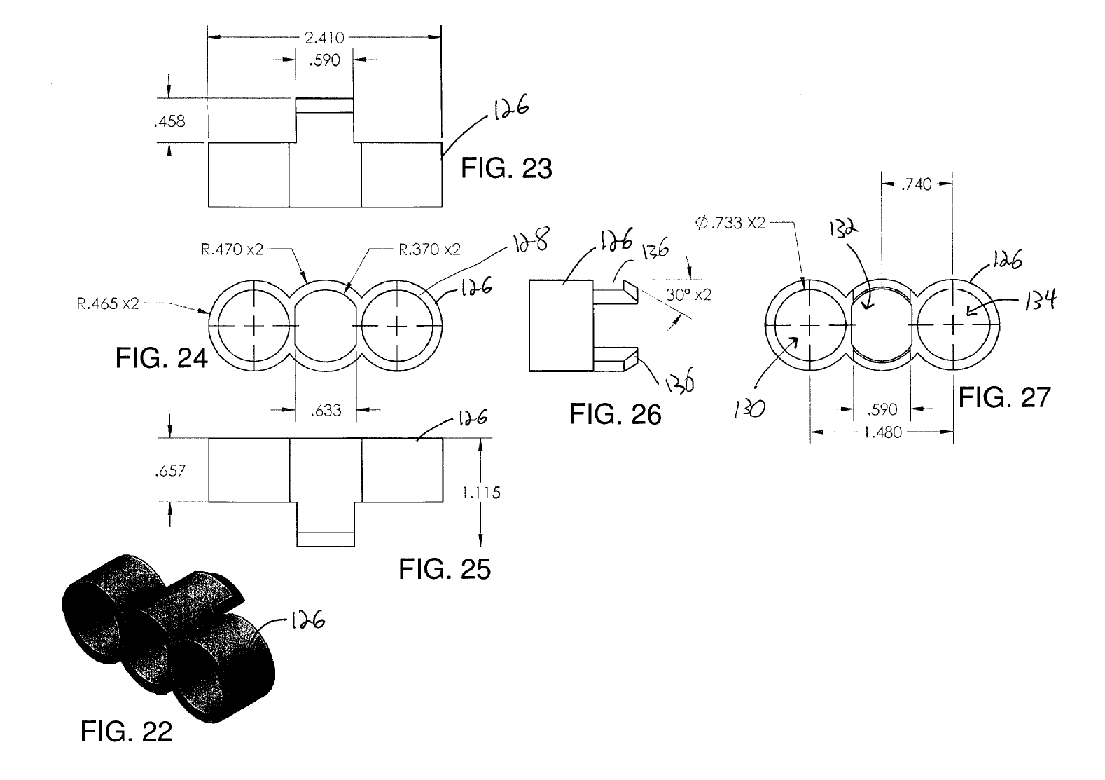

A LNB spacer 126 is shown in FIGS. 22-27. The LNB spacer 126 is disposed between the LNB inlet and the base plate 148 as shown in FIGS. 28 and 29. The LNB spacer 126 includes a perimeter surface sidewall 128 defining three apertures 130, 132 and 134 corresponding to the three inlets of the LNB 124. The specific number of apertures can be varied to match the number of inlets of the LNB 124 employed.

The sidewall adjacent front and back portions of the center aperture 132 extends outwardly towards the LNB 124 to define a pair of flanges 136. The flanges 136 secure the spacer 126 to the LNB in a lateral direction. The opposing side of the spacer opposite the flanges is flat so that it can slide against the base plate 148. The LNB spacer 126 functions to provide a continuous throat surface from the wave guide interior to the sensors in the LNB 124. That prevents signal from leaving the guide pathway before reaching the sensor.

Referring to FIGS. 28-29, the LNB shifter or slider mechanism assembly is shown along with certain other antenna device components. The waveguide assembly 100 extends outward from the front side of the dish 138 (which is a circular parabolic dish). The dish is pivotally mounted to respective frame side plates 140 via mounting plates 139 such that the dish can change elevation aim. A frame back plate 142 spanning between the side plates 140. The frame back plate 142 can be conveniently used as a mounting point for circuit boards and other control electronics for operation of the antenna device.

The distal end of the wave guide 100 is inserted through the central aperture 144 in the dish and is secured to a respective center aperture 146 defined in base plate 148 coupled to the back side of the dish 144. The base plate 148 is rigidly secured to the dish 138 (e.g. with small screws) so that it does not move independent of the dish 138.

The base plate 148 is generally planar on the side facing the dish, except for a flange 147 protruding outward around the center aperture. The opposing, or back, side of the plate 148 includes a plurality of raised and laterally traversing walls that define an upper horizontal track 150 and a lower horizontal track 152. The tracks are respectively above and below the aperture 146. The tracks define the sliding path for the slide plate (discussed below), which in this example define a linear side-to-side or translating sliding motion. Stop pins 154 are disposed adjacent the sides of the tracks to limit the slide travel of the LNB spacer.

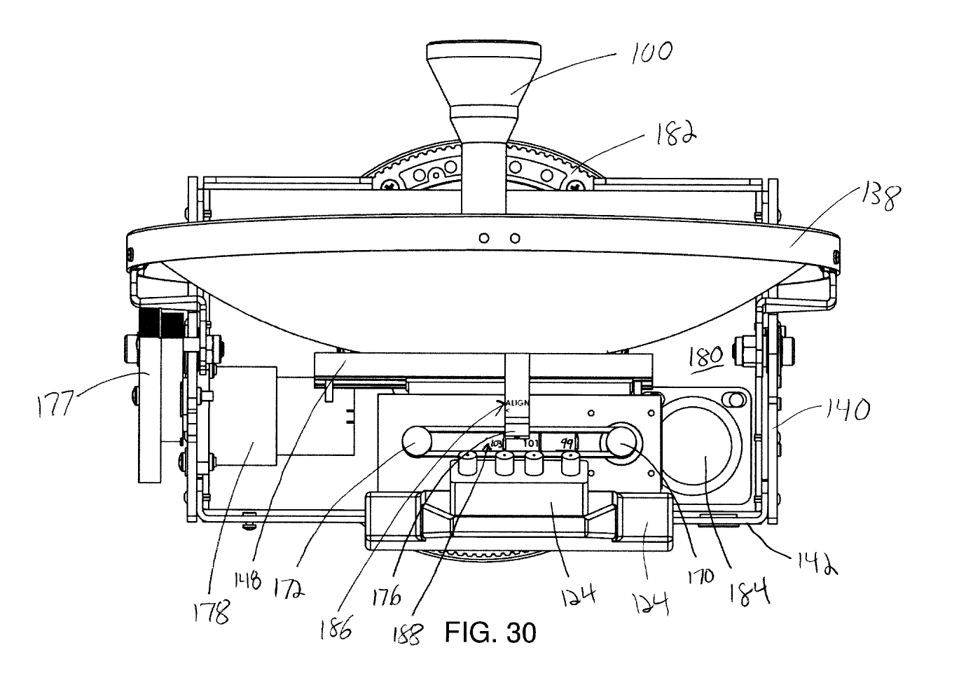

A slide engagement member 156 extends distally away from the dish. The engagement member 156 is rigidly fastened to the base plate 148 and provides an attachment point for the sliding mechanism attached to the slider plate 158. This can also be seen in FIGS. 30-32.

The slider plate 158 includes first and second slider members 160 and 162 extending from a first side. Each slider 160 and 162 corresponds to a respective track 150 and 152. The sliders are sized and shaped to slide along the tracks to define the defined slide motion. The slide plate 158 includes a center aperture 164 sized to permit passage of the LNB spacer 126 and LNB inlet end though the aperture so that the spacer 126 can slide against the back plate 148 between stop pins 154. The LNB 124 is secured to the slider plate 158.

A slide actuator mechanism is disposed on the side of the slide plate 158 opposite the slider members 160 and 162. Referring to FIGS. 28-32, the slide actuator mechanism comprises a drive motor 168 with protruding shaft 170, a pulley 172 spaced apart from the shaft 170 and a belt 174 connecting the pulley 172 and drive shaft 170. A drive coupler 176 is secured to the belt 174 and to the engagement member 156 of the base plate. Thus, turning the drive shaft in a first direction will slide the LNB sideways with respect to the dish in a first direction, while turning the drive shaft in a second direction will slide the LNB sideways with respect to the dish in the opposite direction. Such motion allows the different inlets to the LNB to be selectively aligned with the waveguide assembly 100.

The dish, and various components fastened thereto, can be changed in elevational aim by rotating a side-mounted gear 177. The gear 177 can be rotated by elevation motor 178 disposed on side frame plate 140. The elevation motor 178 is coupled to the gear 177 via a belt.

The dish, and various components fastened thereto, can be rotated in azimuth aim by rotating the bottom frame plate 180, spanning between the side frame plates 140, via a bottom-mounted gear 182 about a hub. The gear 182 can be rotated by azimuth motor 184 disposed on a bottom frame plate 180. The azimuth motor 184 is coupled to the gear 182 via a belt.

In use, the dish 138, wave guide assembly 100 and back plate 148 remain in a fixed position, while the LNB 124 slides horizontally (vertically, etc.) between the 1^{st} Ka, Ku and 2^{nd} Ka alignment positions as will be described with reference to FIGS. 30-32. In FIG. 30, the LNB 124 is positioned so that its first inlet is aligned with the waveguide assembly 100 in a first position defined at the farthest extent of slide travel in the first direction. In the depicted example, this corresponds to the 103° DirecTV satellite position, which broadcasts in the Ka spectrum. Note that the engagement member 156 includes indicia 186 that aligns with a corresponding indicia 188 on the slider plate 158 to provide the user with a visual indication of the current LNB alignment position.

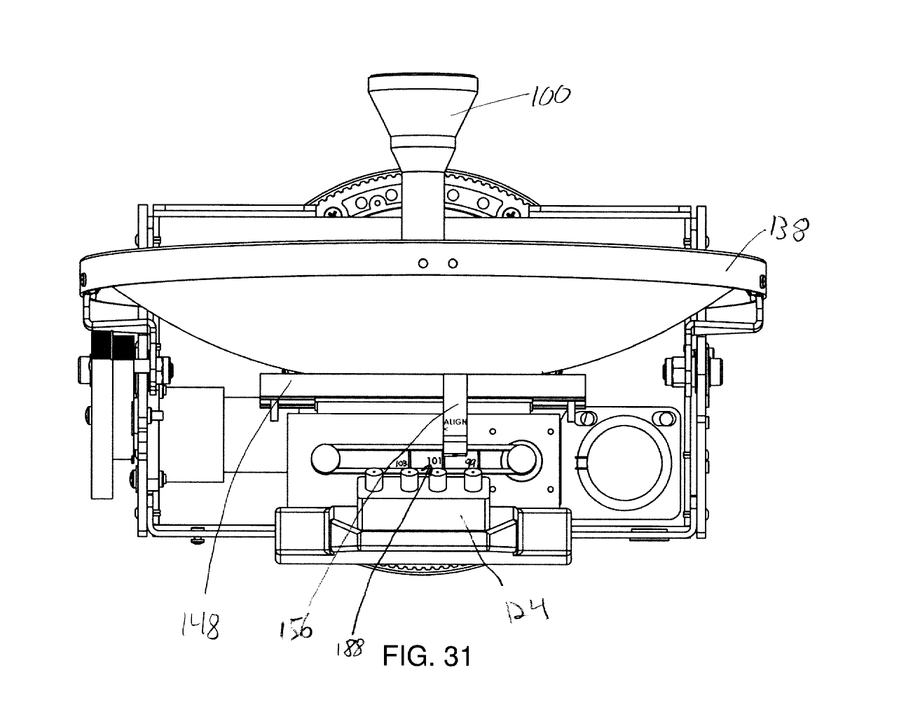

In FIG. 31, the motor 168 has been actuated to slide the LNB sideways to a second position so that the waveguide assembly 100 is now aligned with a second LNB inlet. In this example the alignment corresponds to the 101° DirecTV satellite position, which broadcasts in the Ku spectrum.

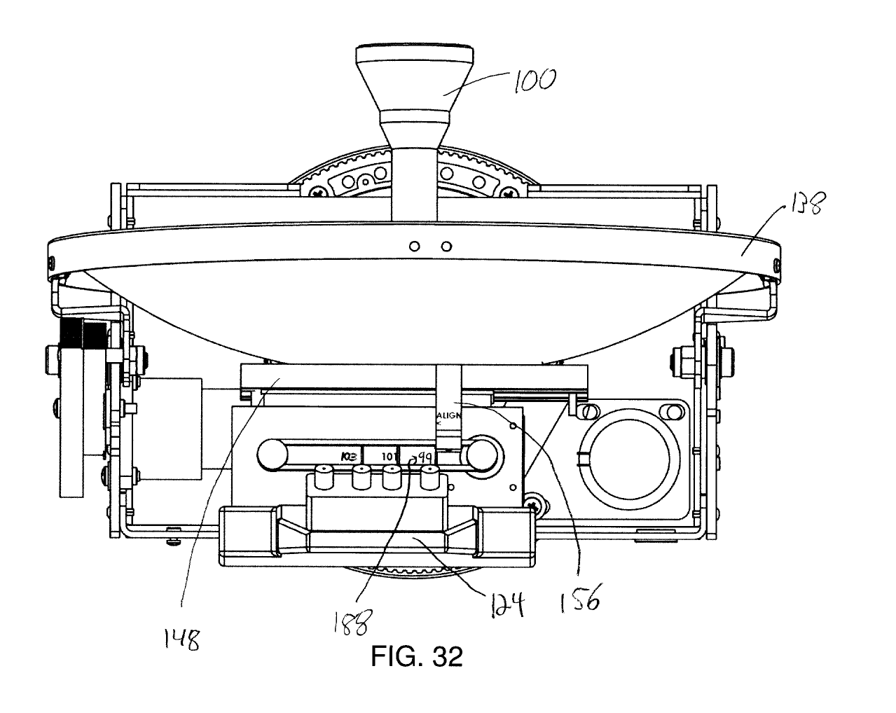

In FIG. 32, the motor 168 has now been actuated to slide the LNB sideways to a third position which is the extent of travel in the second direction so that the waveguide assembly 100 is now aligned with a third LNB inlet. In this example the alignment corresponds to the 99° DirecTV satellite position, which broadcasts in the Ka spectrum.

The LNB alignment can be selectively slid to any of the three (or two or more than three) alignment positions repeatedly and in any order. For example, the LNB can be aligned directly from position one to position three without stopping at position two.

In further use, a user may be watching television on a first channel set according to their set top box. That first channel is being broadcast from a first satellite position (e.g. 99°) with a first broadcast frequency (e.g. in Ka spectrum). Then the user changes the channel to a second channel according to their set top box. The second channel being broadcast from a second satellite position (e.g. 101°) with a second broadcast frequency (e.g. in Ku spectrum). In response to this channel change by the user, the antenna device aims dish in elevation and azimuth to point at the second satellite position (101° in this example). And, the antenna device slides the LNB from a first position where the LNB inlet corresponding to the 99° position and Ka frequency is aligned with the wave guide assembly to a second position where the LNB inlet corresponding to the 101° position and Ku frequency is aligned with the wave guide assembly. The antenna's control system is programmed to automatically energize each of the three motors 168, 178 and 184 to make these changes without the need for the user to provide any input to the antenna other than simply changing channels on the set top box. The antenna control system is configured to respond to the LNB switching protocol utilized by the LNB in order to operative the motors as appropriate to select the correct LNB alignment and dish aim corresponding to the channel chosen by the user.

It can be appreciated that the present invention provides for a satellite TV antenna device, system and methods of use and/or operation that allows the user to receive broadcasts on both the Ka and Ku frequency bands while maintaining enclosure dimensions of conventional Ku-only enclosed satellite TV antennas. Alternative frequency bands can be used in addition, or in the alternative to, the Ka and Ku bands.

The present system can be configured for stationary (both fully automatic and semi-automatic) and in-motion use. Once installed, the system does not need to be deployed prior to use or stored after use or while the vehicle to which it is mounted is in motion. The enclosure protects the interior components from water, debris and other contamination. The system can be controlled by a control system (either inside of the enclosure or external or both) or by responding to the satellite set top receiver/decoder.

While the invention has been described in connection with what is presently considered to be the most practical and preferred example embodiments, it will be apparent to those of ordinary skill in the art that the invention is not to be limited to the disclosed example embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A method of receiving satellite TV broadcasts from a first broadcast satellite broadcasting in a first frequency band and from a second broadcast satellite broadcasting in a second frequency band, the method comprising:
moving an alignment of a low noise block converter (LNB) with respect to a reflector dish from a first alignment position corresponding to the first broadcast satellite to a second alignment position corresponding to the second broadcast satellite,
wherein, in the first alignment position, a first inlet to the LNB corresponding to the first broadcast satellite is aligned with a wave guide extending forwardly from the reflector dish, and
wherein in the second alignment position, a second inlet to the LNB corresponding to the second broadcast satellite is aligned with the wave guide.

2. The method of claim 1, wherein the first frequency band is the Ka band and the second frequency band is the Ku band.

3. The method of claim 1, wherein the first frequency band is different than the second frequency band.

4. The method of claim 1, wherein the wave guide does not move with respect to the reflector dish.

5. The method of claim 1, wherein the step of aligning the LNB includes linearly sliding the LNB along a track.

6. The method of claim 1, further comprising:
securing a base plate to the rear of the reflector dish, the base plate including a track defined therein;
securing the LNB to a slider plate;
engaging the slider plate with the base plate by disposing a slider member of the slider plate in the track of the base plate.

7. The method of claim 1, further comprising turning a driveshaft of a motor to move the LNB with respect to the reflector dish from the first alignment position to the second alignment position.

8. A portable satellite television antenna system configured to receive satellite television broadcasts from a first broadcast satellite broadcasting in a first frequency band and from a second broadcast satellite broadcasting in a second frequency band, the antenna further configured to utilize a LNB including a first inlet corresponding to the first frequency band and a second inlet corresponding to the second frequency band, the system comprising:
a reflector dish having a front reflector side and a back side;
a wave guide extending forward of the front side of the reflector dish;
a slider mechanism disposed behind the back side of the reflector dish and including the LNB coupled thereto, the slider mechanism defining a first position wherein the first inlet of the LNB is with the wave guide and a second position wherein the second inlet of the LNB is aligned with the wave guide, the slider mechanism configured to slide linearly from the first position to the second position; and
a slide motor coupled to the slider mechanism to slide the slider between the first position and the second position.

9. The system of claim 8, wherein the slider mechanism comprises:
a base plate fixedly coupled to the rear side of the reflector dish; and
a sliding plate slidingly coupled to the base plate.

10. The system of claim 9, wherein the slide motor is fixedly coupled to the sliding plate, and the slide motor including a drive shaft engaging drive belt lashed to the base plate.

11. The system of claim 8, further comprising a LNB spacer coupled to the first and second inlets of the LNB, the LNB spacer defining a first aperture therein configured to align with the first inlet of the LNB and a second aperture therein to align with the second inlet of the LNB.

12. The system of claim 8, further comprising:
a pair of opposing side frame plates, the reflector dish being pivotally coupled to the side frame plates to adjust the elevation aim of the reflector dish; and
a bottom frame plate spanning between the side frame plates, the bottom frame being mounted on a rotation hub to adjust the azimuth aim of the dish.

13. The system of claim 8, further comprising a wave guide spacer disposed on a distal end of the wave guide opposite the reflector dish.

14. The system of claim 13, further comprising a subreflector coupled to the wave guide spacer.

15. The system of claim 14, wherein the subreflector comprises an inward-facing surface towards the reflector dish, the inward-facing surface including a conical-shaped protrusion from a center of the subreflector.

16. The system of claim 14, wherein the subreflector comprises a series of recessed circular grooves defined therein in an inward-facing surface towards the reflector dish.

17. A LNB adjustment system for adjusting the alignment of the LNB of a portable satellite television antenna with respect to a wave guide fixedly disposed on a front side of a reflector dish, the system comprising:
a base plate fixedly coupled to a rear side of the reflector dish;
a sliding plate slidingly coupled to the base plate; and
a slide motor is fixedly coupled to the sliding plate and including a drive shaft operably coupled to the base plate,
wherein the LNB is secured to the sliding plate.

18. The system of claim 17, wherein the drive shaft operably coupled to the base plate via a belt lashed to the base plate.

19. The system of claim 17, further comprising a LNB spacer coupled to the LNB, wherein the LNB comprises a first inlet and a second inlet defined therein, the LNB spacer defining a first aperture therein configured to align with the first inlet of the LNB and a second aperture therein to align with the second inlet of the LNB.

20. The system of claim 17, further comprising first and second stop pins coupled to the base plate and arranged to define a slide length for the sliding plate.
